(19) United States
(12) Patent Application Publication
(10) Pub. No.: US 2023/0360176 A1
(43) Pub. Date: Nov. 9, 2023

(54) VISIBLE DATA ENHANCING

(71) Applicant: DISH Network L.L.C., Englewood, CO (US)

(72) Inventor: Caroline Elizabeth Condon, Denver, CO (US)

(73) Assignee: DISH Network L.L.C., Englewood, CO (US)

(21) Appl. No.: 17/736,804

(22) Filed: May 4, 2022

(51) Int. Cl. G06T 5/00; G06T 3/40

(52) U.S. Cl. CPC G06T 5/00; G06T 3/40

(57) ABSTRACT

Devices, systems, and processes for enhancing visible data are described. A process includes computer operations for initiating a visible data capture on a user device; capturing, as first visible data (1VD), an image of an object within a field of view of a camera; determining whether the 1VD includes recognizable data; when recognizable data exists in the 1VD, generating second visible data (2VD) from the 1VD; determining whether actionable data exists in the 2VD; manipulating the actionable data in the 2VD into third visible data (3VD); coupling the user device with a client device; and sending the 3VD to the client device for presentation on a client device display. The 3VD may include an enhancement to the actionable data in the 2VD. The enhancement may change a character from a first font size to a second font size and/or adjust a visible characteristic of the 2VD.

### TECHNICAL FIELD

The technology described herein generally relates to devices, systems, and processes for enhancing visible data.

### BACKGROUND

A given user's ability to visibly see and/or interpret various forms text, icons, and other data (herein, “visible data”) often is diminished due to environment (dark areas, bright areas), font's used, type of font, language used, age of a viewer, and other circumstances. While various smart phone applications exist for image recognition, such as GOOGLE TRANSLATE™, applications commonly utilize a given display on the capturing device, such as a smartphone.

To address such issues with visible data, users commonly utilize reading glasses, magnifying lenses, and the like. With the advent of the smartphone and its camera capabilities, user now often use the camera capabilities of the smartphone to function as a digital magnifier of a given visible data. Reading glasses, magnifiers, smartphones, and the like commonly have limited capabilities with respect to enhancing a given user's perception and understanding of visible data. Often the image displayed on the smartphone is subject to the screen size, clarity, brightness, contrast, and other limitations. Such limitations commonly vary by smartphone. The information provided on a captured image of small visible data is often uninterpretable even when enlarged, and action(s) to be taken relative to the captured image to understand the information, such as providing the same into a product web page, often require use of the smartphone for other purposes, such as Web surfing, or the like. Such other purposes often reduce benefits obtained from magnification of the visible data. Accordingly, the use of visible data, even when enhanced using a smartphone is often of reduced utility for troubleshooting, device configuration, device identification, interpretation of the visible data, and otherwise. Accordingly, the need exists for tools to capture, enlarge, and present visible data in a format acceptable to a given user. Needs also exist for tools which interpret and provide meaningful information obtained from visible data to a given user.

The various implementations and embodiments described herein provide devices, systems and processes which address the above and other concerns.

### SUMMARY

The various implementations described herein provide devices, systems, and processes for visible data enhancement.

In accordance with at least one implementation of the present disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

At least one implementation includes a process that includes initiating a visible data capture on a user device; capturing, as first visible data (“1VD”), an image of an object within a field of view of a camera coupled to the user device; determining whether the 1VD includes recognizable data; when recognizable data exists in the 1VD, generating second visible data (“2VD”) from the 1VD; determining whether actionable data exists in the 2VD; manipulating the actionable data in the 2VD into third visible data (“3VD”); coupling the user device with a client device; and sending the 3VD to the client device for presentation on a client device display. Other embodiments of this aspect include corresponding computer systems, apparatus, and computer programs recorded on one or more computer storage devices, each configured to perform the actions of the methods.

Implementations may include one or more of the following features. The 3VD may include an enhancement to the actionable data in the 2VD. The enhancement may change at least one character in the 2VD from a first font size to a second font size.

The enhancement may adjust a visible characteristic of the 2VD.. The visible characteristic of the 2VD that may be adjusted is at least one of a contrast, shading, hue, tint, brightness characteristic of the 2VD.

The 1VD may identify a serial number of the object.

The user device may be a mobile phone and the user device may include a user device display. The client device display is larger than the user device display. The 3VD may present a larger representation of the actionable data in the 2VD using the client device display than is otherwise possible using the user device display.

A given person may be both a user of the user device and the client.

An additional enhancement may be provided to the client device by one of the user device and the server. The server may be configured to execute non-transient computer instructions which instruct the server to generate and provide the additional enhancement by performing processor executable operations that may include: receiving the 2VD from the user device; enhancing the 2VD into a next instance of the 2VD; communicating the next instance of the 2VD to the user device; and determining whether actionable data is present in the 2VD. When actionable data is present in the 2VD, the server may identify content pertinent to any actionable data in the 2vd and communicate the content to the user device. The process may include: presenting the content on a user device display; and communicating the content to the client device for presentation on a client device display.

The process may include determining whether advisor assistance is to be provided. When advisor assistance is to be provided, the process may include coupling the user device with an advisor device; requesting assistance from the advisor device; determining whether the requested assistance is provided; and when the requested assistance is provided, receiving at least one annotation from the advisor device.

The process may include directly or indirectly communicating the at least one annotation to the client device. The indirectly communicating of the at least one annotation may occur via a fifth coupling of the advisor device with the server, a fourth coupling of the server with a gateway, and a third coupling of the gateway with the client device.

The process may include determining whether advisor assistance is to be provided. When advisor assistance is to be provided, the process may include coupling the user device with an advisor device; requesting the advisor assistance from the advisor device; determining whether the requested advisor assistance is provided; and when the requested advisor assistance is provided, receiving an advisor annotation from the advisor device; and directly or indirectly communicating the advisor annotation to the client device.

The indirectly communicating of the advisor annotation may occur via a fifth coupling of the advisor device with a server, a fourth coupling of the server with a gateway, a second coupling of the gateway with the user device, and a first coupling of the user device with the client device. The gateway may form a local area network which couples the user device with the client device via the second coupling and the third coupling.

The additional content may relate to at least one of the advisor annotation, the 2VD and the 3VD. The advisor annotation may include an annotation of the additional content. The advisor annotation may be provided in at least one of a textual annotation, a graphical annotation, a visual annotation, an audible annotation, an augmented reality annotation, and a virtual reality annotation.

The object may be an electronic device; where the 1VD provides a serial number for the electronic device; where the advisor annotation is with respect to a data port for the electronic device; and where the additional content is a video providing instructions for coupling the electronic device to another electronic device. Implementations of the described techniques may include hardware, a method or process, or computer software on a computer-accessible medium.

### BRIEF DESCRIPTION OF THE DRAWINGS

The features, aspects, advantages, functions, modules, and components of the devices, systems and processes provided by the various embodiments of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic representation of a system for visible data enhancement and in accordance with at least one implementation of the present disclosure.

FIG. 2 is a schematic representation of a user device configured for visible data enhancement and in accordance with at least one implementation of the present disclosure.

FIG. 3 is a schematic representation of a server configured for visible data enhancement and in accordance with at least one implementation of the present disclosure.

FIG. 4 is a schematic representation of a client device configured for visible data enhancement and in accordance with at least one implementation of the present disclosure.

FIG. 5 is a schematic representation of an advisor device configured for visible data enhancement and in accordance with at least one implementation of the present disclosure.

FIG. 6 is a flow chart representing a process instructed by a visible data capture engine instantiated by the user device of FIG. 2 for visible data enhancement and in accordance with at least one implementation of the present disclosure.

FIG. 7 is a flow chart representing a process instructed by a visible data processing engine instantiated by the server of FIG. 3 for visible data enhancement and in accordance with at least one implementation of the present disclosure.

FIG. 8 is a flow chart representing a process instructed by a visible data display engine instantiated by the client device of FIG. 4 for visible data enhancement and in accordance with at least one implementation of the present disclosure.

FIG. 9 is a flow chart representing a process instructed by an advisor annotation engine instantiated by the advisor device of FIG. 5 for visible data enhancement and in accordance with at least one implementation of the present disclosure.

### DETAILED DESCRIPTION

Various implementations of the present disclosure describe devices, systems, and processes for visible data enhancement. For at least one implementation, visible data enhancement may include one or more of capturing visible data using a user device, processing and/or interpreting the captured visible data using one or more of the user device and a server and presenting the as processed and/or as interpreted captured visible data to a user using a client device. For an implementation, visible data enhancement may include presenting “content” (as defined below) related to the capture visible data to the user. Such “content” may be presented using the user device, the client device, and/or other devices.

“Cloud” refers to cloud computing, cloud storage, cloud communications, and/or other technology resources which a given user does not actively manage or provide. A usage of a Cloud resource may be private (limited to certain users and/or uses), public (available for many users and/or uses), hybrid, dedicated, non-dedicated, or otherwise. It is to be appreciated that implementations of the present disclosure may use Cloud resources to provide for processing, storage and other functions related to facilitating live cell phone watch parties.

“Computer Data” refers to any representation of facts, information, or concepts in a form suitable for processing by one or more electronic device processors and which, while and/or upon being processed, cause or result in an electronic device or other device to perform at least one function, task, operation, provide a result, or otherwise. Computer data may exist in a transient and/or non-transient form, as determined by any given use of the computer data.

“Computer engine” (or “engine”) refers to a combination of a “processor” (as described herein) and “computer instruction(s)” (as described herein). A computer engine executes computer instructions to perform one or more logical operations (herein, a “logic”) which facilitate various actual (non-logical) and tangible features and function provided by a system, a device, and/or combinations thereof.

“Content” refers to any information that may be presented, using a suitable presentation device, to a user in a humanly perceptible format. Non-limiting examples of content include videos, television programs, audio programs, speeches, concerts, gaming images, graphics, or otherwise. Content may include, for example and not by limitation, one or more of sounds, images, video, graphics, gestures, or otherwise. The content may originate from any source, including live and/or recorded, human or artificial intelligence, augmented reality, virtual reality, computer generated, or otherwise. The content may be presented to a given user using one or more of a mobile device and/or a “display device” (as described below). Content may be made available by a producer, publisher, distributor, a user, or other source of such content. Content may be provided for presentation, to a user or otherwise, in one or more data packets, data streams, or otherwise.

“Coupling” refers to both mechanism(s) and act(s) by which one or more communications links between two or more elements of a given system or elements of a given system element are provided. A coupling may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, Internet of Things (IoT) networks, Cloud based networks, private networks, public networks, or otherwise. One or more communications and networking standards and/or protocols may be used including, without limitation, the TCP/IP suite of protocols, the Extensible Message and Presence Protocol (XMPP), VOIP, Ethernet, Wi-Fi, CDMA, GSM/GRPS, TDMA/EDGE, EV/DO, WiMAX, SDR, LTE, MPEG, and others. A coupling may include use of physical data processing and communication components. A coupling may be physically and/or virtually instantiated. Non-limiting examples of physical network components include data processing and communications components including computer servers, blade servers, switches, routers, encryption components. decryption components, and other data security components, data storage and warehousing components, and otherwise. Any known or later arising physical and/or virtual data processing and/or communications components may be utilized for a given coupling.

“Instruction” (which is also referred to herein as a “computer instruction”) refers to a non-transient processor executable instruction, associated computer data structures, sequence of operations, program modules, or the like. An instruction is defined by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise.

“Module” recites definite structure for an electrical/electronic device that is configured to provide at least one feature and/or output signal and/or perform at least one function including the features, output signals and functions described herein. Such a module may provide the one or more functions using computer engines, processors, computer instructions and the like. When a feature, output signal and/or function is provided, in whole or in part, using a processor, one more software components may be used, and a given module may be include a processor configured to execute computer instructions. A person of ordinary skill in the art (a “POSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other sources on an as needed basis, or otherwise. Any known or later arising technologies may be used to provide a given module and the features and functions supported therein.

“Processor” refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Small” refers to an item of “visible data” (as described herein), as presented on a surface of a physical object (such as an electronic device chassis, as screen display, a pill, a packaging insert, or otherwise) in a manner that is equivalent to or less than a given font size, type, language, or another characteristic. Whether a given visible data is small may be determined in view of a default setting, such as a ten (10) point or less font size being a default setting. For an implementation, whether a given visible data is small may be determined based on one or more preferences, such as a “user” preference, a “client” preference, an “agent” preference, an “advisor” preference, or otherwise (herein, individually, and collectively, a “preference”). It is to be appreciated that users, clients, agents and advisors may have one or more similar, same, or different preferences. Preferences may also vary based on context, visible data captured, time, location, place and otherwise.

“Substantially simultaneous(ly)” means without incurring a greater than expected and humanly perceptible delay between a first event or condition, such as a presentation of content obtained from one or more first data packets, and a presentation of a second content obtained from one or more second data packets. Substantial simultaneity may vary in a range of quickest to slowest expected delay to longer delay. It is to be appreciated that the subject and acceptable threshold of “substantial simultaneity” is also distance, data processing, and data communication capabilities dependent. For example, content provided in data packets over gigabit Ethernet capable local area network (LAN) connections may have a shorter acceptable delay period (and a more stringent substantially simultaneous requirement) than content presented over a 3G network, where data communications are knowingly slower and thus a given (longer) delay period may satisfy a subject substantially simultaneous threshold.

“Visible data” refers to data provided on a physical device, (herein a “visible data medium”) for perception by a given human user (herein, a “user”). Non-limiting examples of visible data mediums include medicine pills, electronic device chassis, labels, or otherwise. Visible data may have any form, font, size, language, characters, symbols, images, graphics, or otherwise. Visible data may be converted into computer data by use of image capture devices, and associated processing routines.

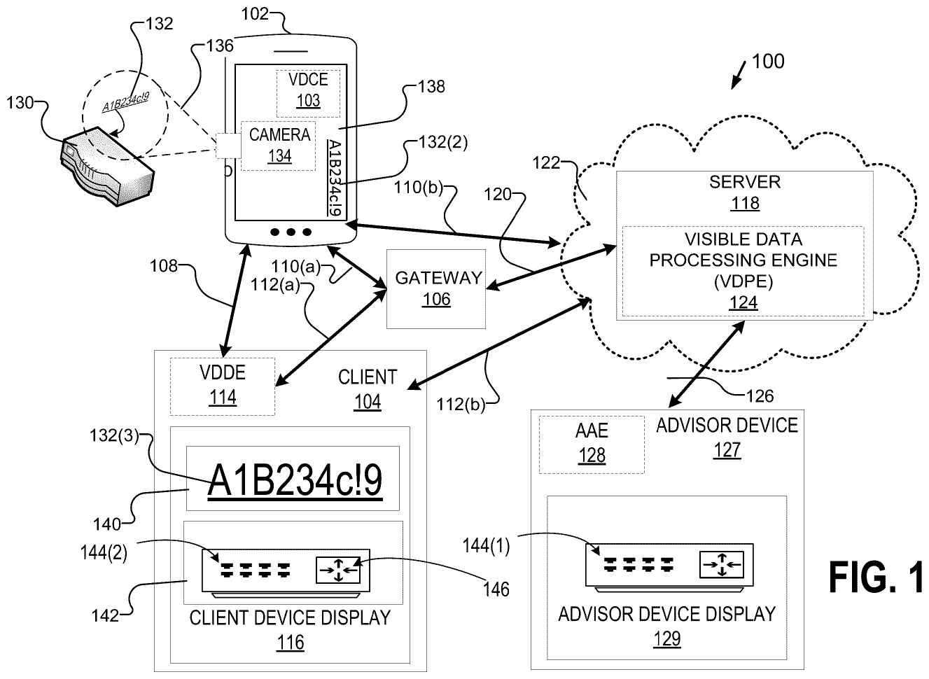

As shown in FIG. 1, a system 100 for visible data enhancing (“VDE”) may include a user device 102, a client device 104, and a gateway device 106. For an implementation, the system 100 may also include a server 118. For another implementation, the system 100 may include an advisor device 128. Herein, a “user” is a person that operates, directly or indirectly, a user device 102 directly, a “client” is a person that operates, directly or indirectly, a client device 104, an “agent” is a person, machine, artificial intelligence, computer process, or the like that directly or indirectly controls operations of a server 118, and an “advisor” is a person that operates, directly or indirectly, an advisor device 127.

Visible data 132 may be provided on a visible data medium 130. The visible data 132 may be provided transiently (such as a blinking light, information temporarily on a display), as a series of light emitting diodes (LEDs), or otherwise. The visible data 132 may be provided on the visible data medium permanently and/or non-transiently, for example, and not by limitation, a serial number on a chassis, a pill code imprinted on a medicine pill, a label affixed to the visible data medium, or otherwise.

The user device 102 may include a camera 134 configured to capture the visible data 132. The camera 134 may be provided with or otherwise coupled to the user device 102. The camera 134 may have at least one field of view 136 within which the visible data 132 may be captured. The camera 134 may be configured to have a fixed or variable field of view 136, fixed and/or varying focal lengths, and fixed and/or varying focal points. Such fields of view, focal lengths and focal points may be provided by physical properties of the camera 134, such as by lens and image sensor planes used, and/or by logical properties of the camera 134, such as by use of known and/or later arising image processing technologies, non-limiting examples including digital zoom, optical character recognition, bar code readers, and the like.

The user device 102 may include a visible data capture engine (VDCE) 103. The VDCE may be configured to present the visible data 132, as captured by the camera 134, as second visible data 132(2) on a user device display 138 of the user device 102 and for presentation to a user of the user device 102.

The second visible data 132(2) may vary from the visible data 132 in size, type, language, font, or otherwise. For a non-limiting example, visible data 132 may be provided in an eight (8) point font and presented as second visible data 132(2) on the user device display 138 in a twelve (12) point font. For another non-limiting example, visible data 132 containing a bar code or QR code may be presented as second visible data 132(2) as a hyperlink to a web page identified by the QR code.

The client device 104 may include a visible data display engine (“VDDE”) 114 and a client device display 116. The VDDE 114 may be included with or provided separately of the client device display 116. Non-limiting examples of a client device display 116 include televisions, computer monitors, and the like. The VDDE 114 may be configured to present the second visible data 132(2), as captured by the user device 102, as a third visible data 132(3) on a client device display 116. The client device display 116 may be configured to present the third visible data 132(3) in a visible data window 140.

The advisor device 127 may include an advisor annotation engine (“AAE”) 128 configured to facilitate annotation of visible data 132 and/or content 144. For a non-limiting example, an AAE may configure an advisor device 127 to present an instance of the visible data 132 and/or content 144(1) to be annotated and one or more tools (not shown) by which an advisor may so annotate the content 144(1).

The client device 104 may be further configured to present a second instance of the content 144(2) in a content window 142. For an implementation, the content 144 may include a representation of all or a portion of the visible data medium 130 with respect to which the third visible data 132(3) relates. For an implementation, the client display device 116 may be configured display one or more annotations 146 provided by the server 118 and/or an advisor 128 regarding the visible data medium 130, the visible data 132, second visible data 132(2) and/or third visible data 132(3), or otherwise. For example, an advisor may provide an annotation 146 indicating which button on the visible data medium 130 functions as a factory reset, power on/off, or other function.

The various elements of the system 100 may be communicatively coupled. For a non-limiting example, the user device 102 may be coupled to the client device 104 directly via a first coupling 108 or indirectly via a second coupling 110 and a third coupling 112. The user device 102 may also be coupled to the network 122 via the gateway 106, as shown by coupling 110(a) and/or directly, as shown by second coupling 110(b). Herein, such couplings are referred to interchangeably as the second coupling 110. The client device 104 may also be coupled to the network 122 via the gateway 106, as shown by coupling 112(a) and/or directly as shown by coupling 112(b). Herein, such couplings are referred to interchangeably as the third coupling 112. For an implementation, the first, second, and third couplings may utilize a Local Area Network (LAN) and/or other communications technologies. For an implementation, the gateway 106 may be coupled to the server 118 by a fourth coupling 120. The fourth coupling 120 may utilize a network 122, such as the Internet. For an implementation, the server 118 may be coupled to the advisor device 128 by a fifth coupling 126. The first coupling 108, second coupling 110, third coupling 112, fourth coupling 120, and fifth coupling 126 may utilize any known or later arising communications technologies including wired and wireless technologies.

User Device 102

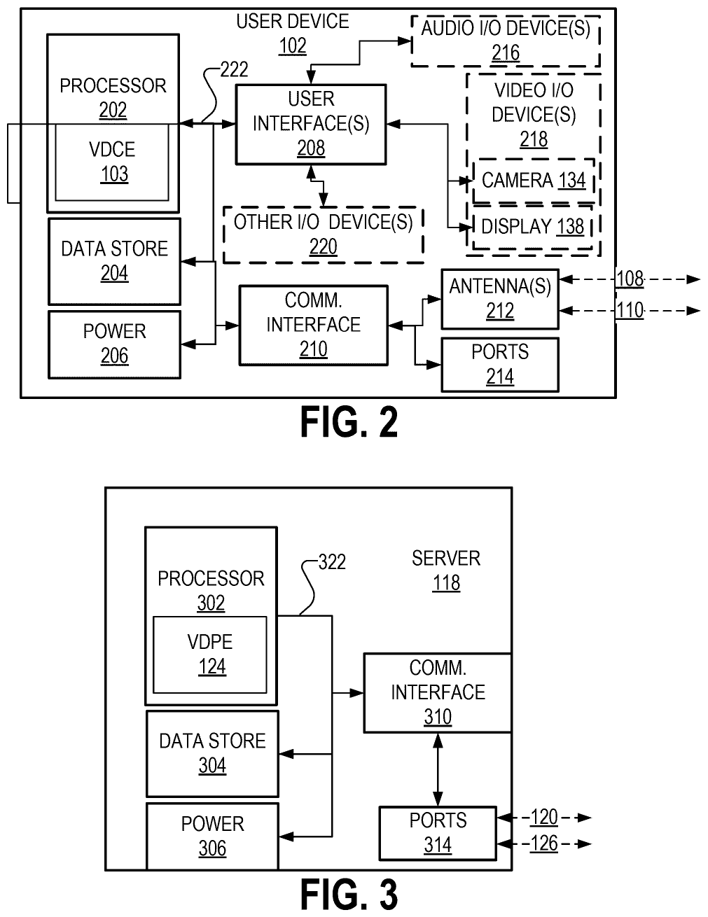

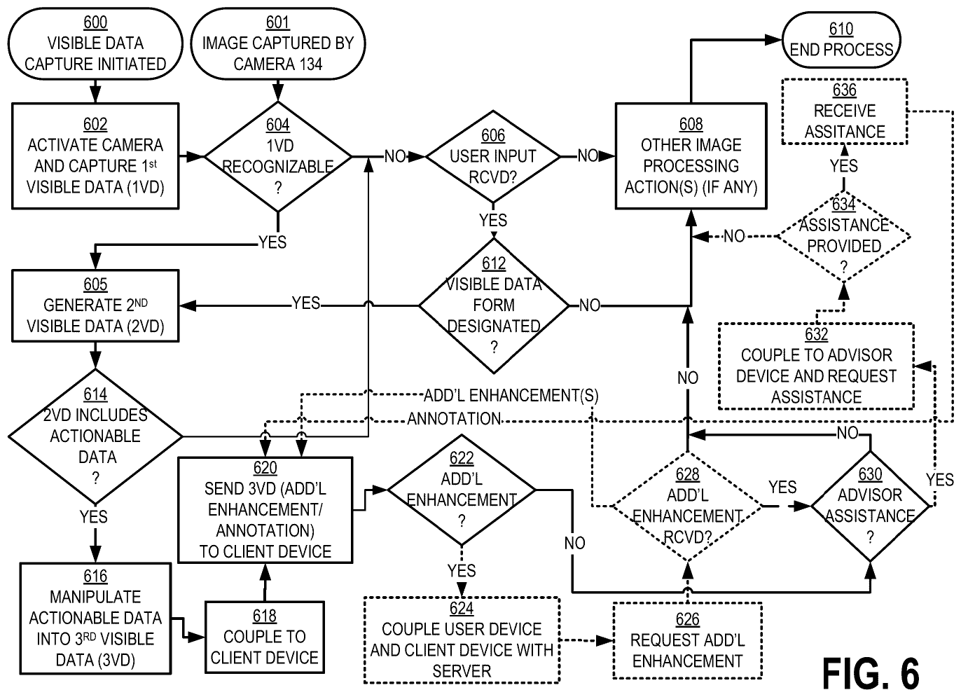

As shown in FIG. 2, a user device 102 may include a processor 202 configured to instantiate the VDCE 103 by executing computer instructions. When instantiated, the VDCE 103 instructs the user device 102 to perform operations for capturing visible data 132. For one implementation, such operations are identified in FIG. 6.

The user device 102 also includes a user device data store 204, a user device power supply 206, a user interface 208, a user device communications interface 210, one or more antennas 212, one or more data ports 214, one or more audio input/output (“I/O”) devices 216, a display 136, one or more other I/O devices 220, and the like.

For at least one implementation, the user device 102 may have one of various forms of computing devices, with non-limiting examples including smartphones, tablet computing devices, laptop computers, digital cameras, and the like.

User Device Processor 202

The user device 102 may include a user device processor 202 (herein, also identified as a server central processing unit (“CPU”)). Any known or later arising processor may be used. The user device processor 202 may be provided by a processing device capable facilitating one or more logics by executing one more computer instructions with respect to data and visible data. The VDCE 103 may be executed by one or more threads on the user device processor 202, or otherwise. The user device processor 202 may include one or more physical components configured for such data processing operations. Any known or later arising technologies may be utilized in conjunction with an implementation of the present disclosure to facilitate the user device processor 202 and the VCDE 103.

The user device processor 202 may instantiate one or more computer engines as one or more threads operating on a computing system having a multiple threaded operating system, such as the WINDOWS 10 operating system, LINUX, APPLE OS, ANDROID, and others, as an application program on a given device, as a web service, or otherwise. An Application Program Interface (API) may be used to support an implementation of the present disclosure. The user device processor 202 may be provided in the virtual domain and/or in the physical domain. The user device processor 202 may be associated with a machine process executing on one or more computing devices, an API, a web service, instantiated on the Cloud, distributed across multiple computing devices, or otherwise. The user device processor 202 may be configurable to communicate data and visible using a network, directly or indirectly, to the client device 104, to the server 118, or otherwise.

The user device processor 202 may be communicatively coupled, by a user device data bus 222 or similar structure, to other components of the user device 102 including, but not limited to, a user device data store 204, which may also be referred to as a “computer readable storage medium.”

User Device Data Store 204

The user device data store 204 may be a storage, multiple storages, or otherwise. The user device data store 204 may be configured to store loop over index files, data packets, and other data. The user device data store 204 may be provided locally with the user device 102 or remotely, such as by a data storage service provided on the Cloud, and/or otherwise. Storage of data, including but not limited to visible data and other data may be managed by a storage controller (not shown) or similar component. It is to be appreciated such storage controller manages the storing of data and may be instantiated in one or more of the user device data store 204, the user device processor 202, on the Cloud, or otherwise. Any known or later arising storage technologies may be utilized in conjunction with an implementation of the present disclosure to facilitate the user device data store 204.

Any known or later arising storage technologies may be utilized for the user device data store 204. Non-limiting examples of devices that may be configured for use as user device data store 204 include electrical storages, such as EEPROMs, random access memory (RAM), Flash drives, and solid-state drives, optical drives such as DVDs and CDs, magnetic storages, such as hard drive discs, magnetic drives, magnetic tapes, memory cards, such as Compact Flash (CF), Secure Digital (SD) cards, Universal Serial Bus (USB) cards, and others.

Available storage provided by the user device data store 204 may be partitioned or otherwise designated by the storage controller as providing for permanent storage and temporary storage. Non-transient data, one or more instances of visible data 132, computer instructions, or other the like may be suitably stored in the user device data store 204. As used herein, permanent storage is distinguished from temporary storage, with the latter providing a location for temporarily storing data, variables, or other instructions used for a then arising data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions, and other data.

The user device data store 204 may be configured to organize data into one or more logical structures, such as a hierarchical database, or otherwise. For at least one implementation, a user device data store 204 may be configured to store one or more preferences in one or more preferences data files (not shown). The preferences data files may identify when visible data is “small.” A given preference may be specified in terms of one or more information characteristics, such as font size, font characteristic, contrast of the given visible data with a background (e.g., medicine pill markings are often pressed into the pill and thus of low contrast), lighting characteristics such as low light, high light, or otherwise. A given preference may identify a given client display device 116 to utilize for visible data enhancement, minimum specifications for a client display device 116, such as size, location, resolution, or the like, and/or other data useful in selecting and/or configuring a client display device 116 for use in visible data enhancement operations.

The user device data store 204 may be configured to store default settings for when visible data is “small” in one or more default setting data files. The default settings may be fixed and/or changeable. The default settings may be specified in terms of one or more user parameters, such as age, reading glass type used, distance vision glasses strength, or the like.

User Device Power Supply 206

The user device 102 may include a user device power supply 206. The user device power supply 206 may include any known or later arising technologies which facilitate the use of electrical energy by the user device. Non-limiting examples of such technologies include batteries, power converters, inductive charging components, line-power components, solar power components, and otherwise.

User Interface 208

The user device 102 may include a user interface 208. The user interface 208 may include any known or later arising human to device interface components, processes, and technologies. Non-limiting examples of interface components include audible input/output (“I/O”) interfaces for use with audio I/O devices 216, visual I/O interfaces for use with visual I/O devices 218 such as camera 134, user device display 138, and the like.

For at least one implementation, an audio I/O interface may support a receiving and/or presenting of audible content. Such audible content (which is also referred to herein as being “audible signals”) may include spoken text, sounds, or any other audible information. Such audible signals may include one or more of humanly perceptible audio signals, where humanly perceptible audio signals typically arise between 20 Hz and 20 KHz. The range of humanly perceptible audio signals may be configurable to support an audible range of a given individual user.

An audio I/O interface generally includes hardware and computer instructions (herein, “audio technologies”) which supports the input and output of audible signals between a user and a device, such as the user device 102 and human user thereof (not shown). Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise.

An audio I/O interface may use one or more microphones and speakers to capture and present audible signals respectively from and to a user. Such one or more microphones and speakers may be provided by the user device 102 or otherwise. For example, earbuds may be communicatively coupled to a smartphone, with the earbuds functioning as an audio I/O interface and capturing and presenting audio signals as sound waves to and from a user, while the smartphone functions as the user device 102.

A visual I/O interface generally includes hardware and computer instructions (herein, “visible technologies”) which supports the input by and output of visible signals to a user using a user device 102. Such visible technologies may include, but are not limited to, the camera 134, user device display 138 and/or other devices and technologies for converting images (in any spectrum range) into humanly perceptible images, converting images of visible data into a given user's perceptible content, such as by character recognition, translation, playback rate adjustment, playback frequency adjustment, and otherwise.

A visual I/O interface may be configured to use one or more visual I/O devices such as the camera 134 and the user device display 138. The user device display 138 may be an internal display (not shown) and/or external display (not shown), that are configured to present visible data, and other data to a user. A visual I/O interface may be configured to use one or more image capture devices. Non-limiting examples include lenses, digital image capture and processing software and the like. Accordingly, it is to be appreciated that any existing or future arising visual I/O interfaces, devices, systems and/or components may be utilized.

Other forms of I/O devices 220 may be provided with and/or coupled to the user device 102. Non-limiting examples include keypads, touch screens, styluses, external keyboards, or the like. Any form of known or later arising I/O device(s) 220 may be utilized by a user device 102 for at least one implementation of the present disclosure.

User Device Communications Interface 210

The user device 102 may include a user device communications interface 210. The user device communications interface 210 may be configured to use any known or later arising communications and/or networking technologies which facilitate coupling of the user device 102 to other system 100 components. One or more antennas 212 and/or data ports 214 (which are also commonly referred to an input/output interfaces, cards, or the like) may be used to facilitate coupling of the user device 102 with one or more other system 100 components. Such communication interfaces are well-known in the art and non-limiting examples include Ethernet cards, USB and storage medium interface cards, radio frequency transceivers, and others. For at least one implementation, the user device communications interface 210 may be configured to couple with one or more antennas 212, such as a DBS antenna, a a broadcast signal antenna (which may be colloquially often referred to as “rabbit ears”), WiFi antennas, Bluetooth antennas, wireless/cellular antennas, and the like.

Referring again to FIG. 2, the user device 102 may be coupled by a first coupling 108 to a client device 104. The user device 102 may be coupled by a second coupling 110 to a gateway 106 and thereby using a third coupling 112 to the client device 104 or a fourth coupling 120 to the server 118. The fourth coupling 120 may be facilitated by use of a network 122, such as a wide area network with one non-limiting example being the Internet. It is commonly known that Internet connections are commonly facilitated by an Internet Service Provider (ISP). The server 118, and thereby the user device 102, may be further coupled, by a fifth coupling 126 to one or more advisor device(s) 127.

VDCE 103

With reference to FIG. 6, the VDCE 103 manages the capturing of visible data 132(1), initial processing of the visible data into second visible data 132(2), and communication of the second visible data 132(2) to one or more of the server 118 and the client device 104. For at least one implementation, operations of the VDCE 103 are illustrated in FIG. 6 herein (as further described below). Such operations are non-limiting and for at least one implementation of the present disclosure. Other operations, sequences thereof, combinations, and/or permutations thereof may be used in accordance with other implementations of the present disclosure. For at least one implementation, the VDCE 103 may be instantiated by a user device 102, where the user device 102 includes a processor configured to provide the VDCE 103.

Gateway 106

Referring again to FIG. 1, the gateway 106 may be any device that may be configured to couple the user device 102 with one or more of the client device 104, the server 118 and/or an advisor device 127. For at least one implementation, the gateway 106 may be a set-top-box (STB), such as one provided by a direct broadcast satellite (DBS) provider such as DISH Network and DirecTV, a cable provider, such as Comcast and Cox Communications. The gateway 106 may include and/or be embedded in smart TV, in a 10-foot device, such as a Roku Inc. ROKU™ device, an Apple Inc., APPLETV™ device, a Google Inc. CHROMECAST™ device, or the like. For at least one implementation, the gateway 106 may include a streaming application such as a NETFLIX™ application, a PARAMOUNT+™ application, a YOUTUBE™ application, or the like, or otherwise. It is commonly known that streaming applications and the like may be hosted on various forms of computing devices, with non-limiting examples including smartphones, tablet computing devices, laptop computers, STBs, “smart” televisions, appliances, and the like, and otherwise. In short, any known and/or later arising computing devices configured to facilitate coupling of a user device 102 with a client device 104, server 118 and/or advisor device 127 for visible data enhancement.

For at least one implementation, one or more functions and/or capabilities of a server 118 (as described below) may be provided in a gateway 106.

Server 118

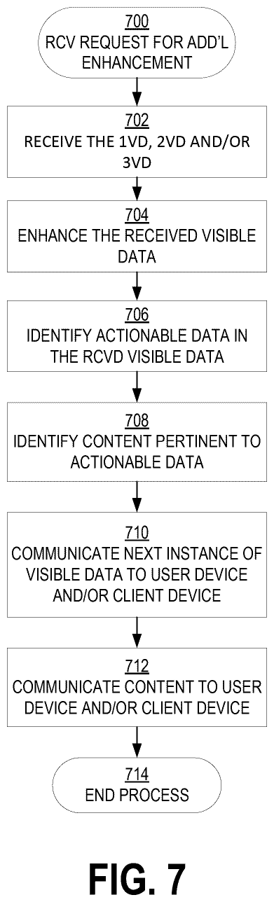

As shown in FIG. 3, a server 118 may include a server processor 302 configured to instantiate the VDPE 124 by executing computer instructions. When instantiated, the VDPE 124 instructs the server 118 to perform operations for analyzing visible data 132 and generating third visible data 132(3) for presentation by the client device 104. For one implementation, such operations are identified in FIG. 7.

The server 118 may also include a server data store 304, a server power supply 306, a server user interface (not shown), a server communications interface 310, one or more antennas (not shown), one or more data ports 314, one or more audio, video, and/or other I/O devices (not shown), and the like. For at least one implementation, the server 118 may have one of various forms of computing devices, with non-limiting examples including smartphones, tablet computing devices, laptop computers, digital cameras, and the like.

Server Processor 302

The server 118 may include a server processor 302 (herein, also identified as a “server CPU”). Any known or later arising processor may be used. The server processor 302 may be provided by a processing device capable facilitating one or more logics by executing one more computer instructions with respect to data. The VDPE 124 may be executed by one or more threads on the server processor 302, or otherwise. The server processor 302 may include one or more physical components configured for such data processing operations. Any known or later arising technologies may be utilized in conjunction with an implementation of the present disclosure to facilitate the server processor 302 and the VDPE 124.

The server 118 may instantiate one or more computer engines as one or more threads operating on a computing system having a multiple threaded operating system, such as the WINDOWS 10 operating system, LINUX, APPLE OS, ANDROID, and others, as an application program on a given device, as a web service, or otherwise. An Application Program Interface (API) may be used to support an implementation of the present disclosure. The server 118 may be provided in the virtual domain and/or in the physical domain. The server 118 may be associated with a human user, a machine process executing on one or more computing devices, an API, a web service, instantiated on the Cloud, distributed across multiple computing devices, or otherwise. The server 118 may be any electronic device configurable to communicate data using a network, directly or indirectly, to another device, to another server, or otherwise.

The server processor 302 may be communicatively coupled, by a server data bus 322 or similar structure, to other components of the server 118 including, but not limited to, a server data store 304, which may also be referred to as a “computer readable storage medium.”

VDPE 124

With reference to FIG. 7, the VDPE 124 facilitates analysis and enhancements of visible data 132, as provided by the user device 102 as second visible data 132(2), as output to a client device as third visible data 132(3). The VDPE 124 also facilitates the providing of content 144, as received from an advisor device 127 as first content 144(1) and/or as provided to a client device 104 for presentation as second content 144(2), wherein the second content 144(2) may include one or more annotations 146 provided by an advisor using an advisor device 127. As discussed below, an advisor may be a human, an automated process, an artificial intelligence process, a combination of the foregoing, or otherwise.

For at least one implementation, operations of the VDPE 124 are illustrated in FIG. 7 herein (as further described below). Such operations are non-limiting and for at least one implementation of the present disclosure. Other operations, sequences thereof, combinations, and/or permutations thereof may be used in accordance with other implementations of the present disclosure. For at least one implementation, the VDPE 124 may be instantiated, in whole, in part, and/or in various permutations and combinations, in a user device 102, a gateway 106, a client device 104, and/or in an advisor device 127; where the corresponding system component includes a processor configured to provide one or more features and functions of the VDPE 124.

Server Data store 304

The server data store 304 may be a storage, multiple storages, or otherwise. The server data store 304 may be configured to store one or more instances of visible data 132, content 144, annotations 146, preferences, default settings, or other data. The server data store 304 may be provided locally with the server 118 or remotely, such as by a data storage service provided on the Cloud, and/or otherwise. Storage of data may be managed by a storage controller (not shown) or similar component. It is to be appreciated such storage controller manages the storing of data and may be instantiated in one or more of the server data store 304, the server processor 302, on the Cloud, or otherwise. Any known or later arising storage technologies may be utilized in conjunction with an implementation of the present disclosure to facilitate the server data store 304.

Any known or later arising storage technologies may be utilized for the server data store 304. Non-limiting examples of devices that may be configured for use as server data store 304 include electrical storages, such as EEPROMs, random access memory (RAM), Flash drives, and solid-state drives, optical drives such as DVDs and CDs, magnetic storages, such as hard drive discs, magnetic drives, magnetic tapes, memory cards, such as Compact Flash (CF), Secure Digital (SD) cards, Universal Serial Bus (USB) cards, and others.

Available storage provided by the server data store 304 may be partitioned or otherwise designated by the storage controller as providing for permanent storage and temporary storage. Non-transient data, computer instructions, or other the like may be suitably stored in the server data store 304. As used herein, permanent storage is distinguished from temporary storage, with the latter providing a location for temporarily storing data, variables, or other instructions used for a then arising data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions, and other data.

Server Power Supply 306

The server 118 may include a server power supply 306. The server power supply 306 may include any known or later arising technologies which facilitate the use of electrical energy by the server 118. Non-limiting examples of such technologies include batteries, power converters, inductive charging components, line-power components, solar power components, and otherwise.

Server Agent interface

The server 118 may include a server agent interface (not shown). The server agent interface may include any known or later arising human to device interface components, processes, and technologies. Non-limiting examples of interface components include audible, visible, and other I/O interfaces (as described above).

Server Communications Interface 310

The server 118 may include a server communications interface 310. The server communications interface 310 may be configured to use any known or later arising communications and/or networking technologies which facilitate coupling of the server 118 to other system 100 components. One or more data ports 314 (which are also commonly referred to an input/output interfaces, cards, or the like) may be used to facilitate coupling of the server 118 with one or more other system 100 components. Such communication interfaces are well-known in the art and non-limiting examples include Ethernet cards, USB and storage medium interface cards, radio frequency transceivers, and others. For at least one implementation, the communications interface 310 may be configured to couple with one or more antennas (not shown) with non-limiting examples of types of antennas being described above.

Referring again to FIG. 1, the server 118 may be coupled by a fourth coupling 120 to the Internet 122, as may be commonly facilitated by an Internet Service Provider (ISP) and/or a content distributor 210 (herein, a “distributor”), such as a DISH Network, or the like.

Client Device 104

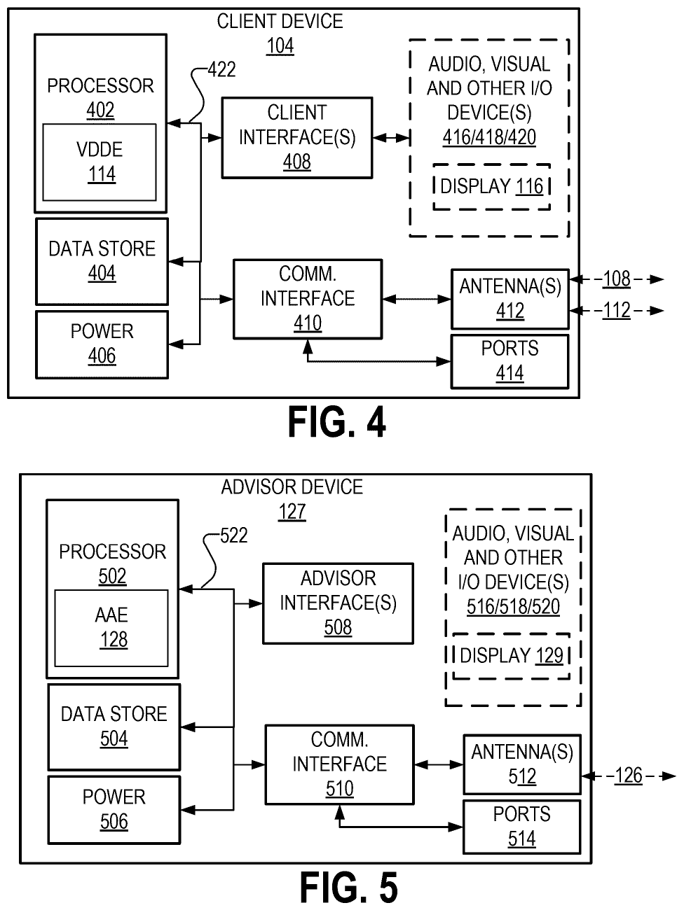

As shown in FIG. 4, a client device is a device and/or combinations thereof used to present visible data and content in a humanly perceptible format to at least one client. A client device 104 may include and/or be communicatively coupled to one or presentation devices, such as a client device display 116, audible output device, or otherwise. Non-limiting examples of a client device 104 include smart phones, smart televisions, tablet computing devices, lap-top computers, desk-top computers, gaming consoles, cable/satellite set-top-boxes (STB), 10-Foot presentation devices, and others. Any known or later arising device configured and/or configurable to present visible data and/or content to a given user may be utilized in an implementation of the present disclosure.

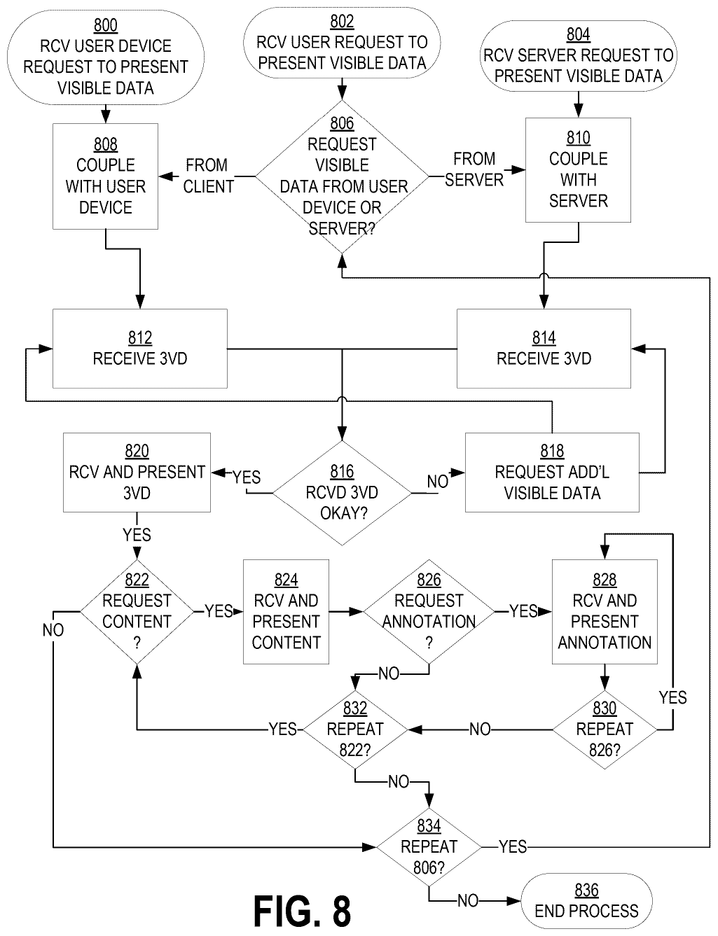

A client device 104 may include a client device processor 402 configured to instantiate the VDDE 114 by executing computer instructions. When instantiated, the VDDE 114 instructs the client device 104 to perform operations for capturing visible data 132. For one implementation, such operations are identified in FIG. 8.

The client device 104 also includes a client device data store 404, a client device power supply 406, a client interface 408, a client device communications interface 410, one or more antennas 412, one or more data ports 414, one or more audio input/output (“I/O”) devices 416/418, a display 136, one or more other I/O devices 420, and the like.

For at least one implementation, the client device 104 may have one of various forms of computing devices, with non-limiting examples including smartphones, tablet computing devices, laptop computers, digital cameras, and the like.

Client Device Processor 402

The client device 104 may include a client device processor 402 (herein, also identified as a server central processing unit (“CPU”)). Any known or later arising processor may be used. The client device processor 402 may be provided by a processing device capable facilitating one or more logics by executing one more computer instructions with respect to data and visible data. The VDDE 114 may be executed by one or more threads on the client device processor 402, or otherwise. The client device processor 402 may include one or more physical components configured for such data processing operations. Any known or later arising technologies may be utilized in conjunction with an implementation of the present disclosure to facilitate the client device processor 402 and the VDDE 114.

The client device processor 402 may instantiate one or more computer engines as one or more threads operating on a computing system having a multiple threaded operating system, such as the WINDOWS 10 operating system, LINUX, APPLE OS, ANDROID, and others, as an application program on a given device, as a web service, or otherwise. An Application Program Interface (API) may be used to support an implementation of the present disclosure. The client device processor 402 may be provided in the virtual domain and/or in the physical domain. The client device processor 402 may be associated with a machine process executing on one or more computing devices, an API, a web service, instantiated on the Cloud, distributed across multiple computing devices, or otherwise. The client device processor 402 may be configurable to communicate data and visible using a network, directly or indirectly, to the user device 102, the gateway 106, the server 118, an advisor device 127, or otherwise.

The client device processor 402 may be communicatively coupled, by a client device data bus 422 or similar structure, to other components of the client device 104 including, but not limited to, a client device data store 404, which may also be referred to as a “computer readable storage medium.”

Client Device Data Store 404

The client device data store 404 may be a storage, multiple storages, or otherwise. The client device data store 404 may be configured to store loop over index files, data packets, and other data. The client device data store 404 may be provided locally with the client device 104 or remotely, such as by a data storage service provided on the Cloud, and/or otherwise. Storage of data, including but not limited to visible data, content, and other data may be managed by a storage controller (not shown) or similar component. It is to be appreciated such storage controller manages the storing of data and may be instantiated in one or more of the client device data store 404, the client device processor 402, on the Cloud, or otherwise. Any known or later arising storage technologies may be utilized in conjunction with an implementation of the present disclosure to facilitate the client device data store 404.

Any known or later arising storage technologies may be utilized for the client device data store 404. Non-limiting examples of devices that may be configured for use as client device data store 404 include electrical storages, such as EEPROMs, random access memory (RAM), Flash drives, and solid-state drives, optical drives such as DVDs and CDs, magnetic storages, such as hard drive discs, magnetic drives, magnetic tapes, memory cards, such as Compact Flash (CF), Secure Digital (SD) cards, Universal Serial Bus (USB) cards, and others.

Available storage provided by the client device data store 404 may be partitioned or otherwise designated by the storage controller as providing for permanent storage and temporary storage. Non-transient data, one or more instances of visible data 132, computer instructions, content 144, or other the like may be suitably stored in the client device data store 404. As used herein, permanent storage is distinguished from temporary storage, with the latter providing a location for temporarily storing data, variables, or other instructions used for a then arising data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions, and other data.

The client device data store 404 may be configured to organize data into one or more logical structures, such as a hierarchical database, or otherwise. For at least one implementation, a client device data store 404 may be configured to store one or more preferences in one or more preferences data files (not shown). The preferences data files may identify when visible data is “small.” A given preference may be specified in terms of one or more information characteristics, such as font size, font characteristic, contrast of the given visible data with a background (e.g., medicine pill markings are often pressed into the pill and thus of low contrast), lighting characteristics such as low light, high light, or otherwise. A given preference may identify a given client display device 116 to utilize for visible data enhancement, minimum specifications for a client display device 116, such as size, location, resolution, or the like, and/or other data useful in selecting and/or configuring a client display device 116 for use in visible data enhancement operations.

The client device data store 404 may be configured to store default settings for when visible data is “small” in one or more default setting data files. The default settings may be fixed and/or changeable. The default settings may be specified in terms of one or more user parameters, such as age, reading glass type used, distance vision glasses strength, or the like.

Client Device Power Supply 406

The client device 104 may include a client device power supply 406. The user client device power supply 406 may include any known or later arising technologies which facilitate the use of electrical energy by the user device. Non-limiting examples of such technologies include batteries, power converters, inductive charging components, line-power components, solar power components, and otherwise.

Client Interface 408

The client device 104 may include a client interface 408. The client interface 408 may include one or more of the components provided by a user interface 208 (as described above) and/or additional and/or alternative user interface components. The client device user interface 408 may be configured for use with and/or include any known or later arising human to device interface components, processes, and technologies. Non-limiting examples of interface components include audible, visible I/O interfaces for use with audio I/O devices 216, visible I/O interfaces for use with visual I/O devices such as client device display 116, and the like.

Client Device Communications Interface 410

The client device 104 may include a client device communications interface 410. The client device communications interface 410 may include one or more of the components provided by a user device communications interface 108 (as described above) and/or additional and/or alternative communications interface components.

Referring again to FIG. 1, the client device 104 may be coupled by a first coupling 108 to a user device 102. The client device 104 may be coupled by a third coupling 112 to a gateway 106 and thereby using a second coupling 110 to the client device 104 or a fourth coupling 120 to the server 118. The fourth coupling 120 may be facilitated by use of a network 122, such as a wide area network with one non-limiting example being the Internet. It is commonly known that Internet connections are commonly facilitated by an Internet Service Provider (ISP). The server 118, and thereby the client device 104, may be further coupled, by a fifth coupling 126 to one or more advisor device(s) 127.

VDDE 114

With reference to FIG. 8, the VDDE 114 manages the presentation of instances of visible data 132, such as a third instances of visible data 132(3). The VDDE 114 may also manage the presentation of content 144 and annotations 146. For at least one implementation, operations of the VDDE 114 are illustrated in FIG. 8 herein (as further described below). Such operations are non-limiting and for at least one implementation of the present disclosure. Other operations, sequences thereof, combinations, and/or permutations thereof may be used in accordance with other implementations of the present disclosure. For at least one implementation, the VDDE 114 may be instantiated by a client device 104, where the client device 104 includes a processor configured to provide the VDDE 114.

Advisor Device 127

As shown in FIG. 5, an advisor device 127 is a device and/or combinations thereof used to present an instance of visible data, identify content relevant thereof, and provide annotation(s) (if any) to the content for presentation on one or more of a user device 102 and/or a client device 104 in a humanly perceptible format. An advisor device 127 may include and/or be communicatively coupled to one or presentation devices, such as an advisor device display 129, audible output device, or otherwise. Non-limiting examples of an advisor device 127 include smart phones, smart televisions, tablet computing devices, lap-top computers, desk-top computers, gaming consoles, cable/satellite set-top-boxes (STB), 10-Foot presentation devices, and others. Any known or later arising device configured and/or configurable to present visible data and/or content to a given user may be utilized in an implementation of the present disclosure.

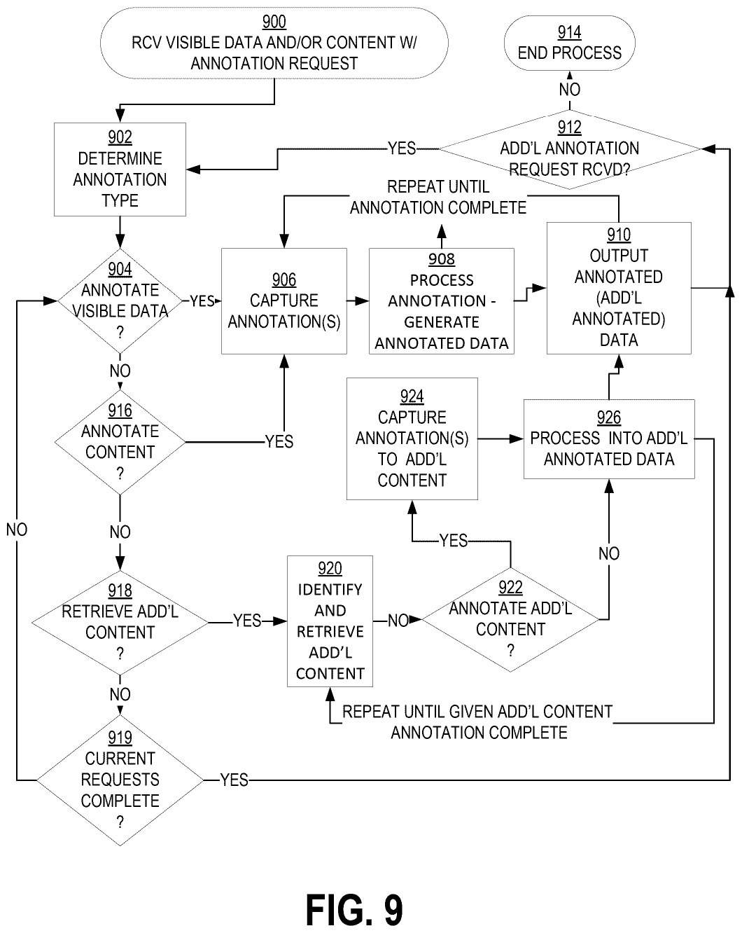

An advisor device 127 may include an advisor device processor 502 configured to instantiate the AAE 128 by executing computer instructions. When instantiated, the AAE 128 instructs the advisor device 1274 to perform operations for identifying content 144 relating to second visible data 132(2), facilitating annotating of the content 144 and/or the second visible data 132(2) to generate and output third visible data 132(3), and other operations. For one implementation, non-limiting examples of operations performed and/or instructed by the AAE 128 are identified in FIG. 9.

The advisor device 127 also includes an advisor device data store 504, an advisor device power supply 506, an advisor interface 508, an advisor device communications interface 510, one or more antennas 512, one or more data ports 514, one or more audio, video, and other I/O devices 516/518/520, the advisor device display 129, and the like.

For at least one implementation, the advisor device 127 may have one of various forms of computing devices, with non-limiting examples including smartphones, tablet computing devices, laptop computers, digital cameras, and the like.

Advisor Device Processor 502

The advisor device 127 may include an advisor device processor 502 (herein, also identified as an advisor device central processing unit (“CPU”)). Any known or later arising processor may be used. The advisor device processor 502 may be provided by a processing device capable facilitating one or more logics by executing one more computer instructions with respect to data and visible data. The AAE 128 may be executed by one or more threads on the advisor device processor 502, or otherwise. The advisor device processor 502 may include one or more physical components configured for such data processing operations. Any known or later arising technologies may be utilized in conjunction with an implementation of the present disclosure to facilitate the advisor device processor 502 and the AAE 127.

The advisor device processor 502 may instantiate one or more computer engines as one or more threads operating on a computing system having a multiple threaded operating system, such as the WINDOWS 10 operating system, LINUX, APPLE OS, ANDROID, and others, as an application program on a given device, as a web service, or otherwise. An Application Program Interface (API) may be used to support an implementation of the present disclosure. The advisor device processor 502 may be provided in the virtual domain and/or in the physical domain. The advisor device processor 502 may be associated with a machine process executing on one or more computing devices, an API, a web service, instantiated on the Cloud, distributed across multiple computing devices, or otherwise. The advisor device processor 502 may be configurable to communicate data and visible using a network, directly or indirectly, to the user device 102, the gateway 106, the server 118, the client device 104, or otherwise.

The advisor device processor 502 may be communicatively coupled, by an advisor device data bus 522 or similar structure, to other components of the advisor device 127 including, but not limited to, an advisor device data store 504, which may also be referred to as a “computer readable storage medium.”

Advisor Device Data Store 504

The advisor device data store 504 may be a storage, multiple storages, or otherwise. The advisor device data store 504 may be configured to store loop over index files, data packets, and other data. The advisor device data store 504 may be provided locally with the advisor device 127 or remotely, such as by a data storage service provided on the Cloud, and/or otherwise. Storage of data, including but not limited to visible data, content, and other data may be managed by a storage controller (not shown) or similar component. It is to be appreciated such storage controller manages the storing of data and may be instantiated in one or more of the advisor device data store 504, the advisor device processor 502, on the Cloud, or otherwise. Any known or later arising storage technologies may be utilized in conjunction with an implementation of the present disclosure to facilitate the advisor device data store 504.

Any known or later arising storage technologies may be utilized for the advisor device data store 504. Non-limiting examples of devices that may be configured for use as an advisor device data store 504 include electrical storages, such as EEPROMs, random access memory (RAM), Flash drives, and solid-state drives, optical drives such as DVDs and CDs, magnetic storages, such as hard drive discs, magnetic drives, magnetic tapes, memory cards, such as Compact Flash (CF), Secure Digital (SD) cards, Universal Serial Bus (USB) cards, and others.

Available storage provided by the advisor device data store 504 may be partitioned or otherwise designated by the storage controller as providing for permanent storage and temporary storage. Non-transient data, one or more instances of visible data 132, computer instructions, content 144, annotations 146, or other data may be suitably stored in the advisor device data store 504. As used herein, permanent storage is distinguished from temporary storage, with the latter providing a location for temporarily storing data, variables, or other instructions used for a then arising data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions, and other data.

The advisor device data store 504 may be configured to organize data into one or more logical structures, such as a hierarchical database, or otherwise. For at least one implementation, an advisor device data store 504 may be configured to store one or more preferences in one or more preferences data files (not shown). The preferences data files may identify forms, type, and other characteristics of content 144 and/or annotations 146 an advisor may provide when visible data is “small” for a given user.

A given preference may be specified in terms of one or more information characteristics, such as font size, font characteristic, contrast of the given visible data with a background (e.g., medicine pill markings are often pressed into the pill and thus of low contrast), lighting characteristics such as low light, high light, or otherwise. A given preference may identify a given client display device 116 to utilize for visible data enhancement, minimum specifications for a client display device 116, such as size, location, resolution, or the like, and/or other data useful in selecting and/or configuring a client display device 116 for use in visible data enhancement operations.

The advisor device data store 504 may be configured to store default settings for when visible data 132 is “small” in one or more default setting data files. The default settings may be fixed and/or changeable. The default settings may be specified in terms of one or more user parameters, such as age, reading glass type used, distance vision glasses strength, or the like.

Advisor Device Power Supply 506

The advisor device 127 may include an advisor device power supply 506. The adviser device power supply 506 may include any known or later arising technologies which facilitate the use of electrical energy by the user device. Non-limiting examples of such technologies include batteries, power converters, inductive charging components, line-power components, solar power components, and otherwise.

Advisor Interface 408

The advisor device 127 may include an advisor interface 508. The advisor interface 508 may include one or more of the audio I/O components, video I/O components and/or other I/O components provided by a client device user interface 208 (as described above) and/or additional and/or alternative user interface components. The advisor interface 508 may be configured for use with and/or include any known or later arising human to device interface components, processes, and technologies. Non-limiting examples of interface components include audible I/O interfaces for use with audio I/O devices 516, visible I/O interfaces for use with visual I/O devices such as adviser device display 129, and the like.

Advisor Device Communications Interface 510

The advisor device 127 may include an advisor device communications interface 510. The advisor device communications interface 510 may include one or more of the components provided by a user device communications interface 108 (as described above) and/or additional and/or alternative communications interface components.

Referring again to FIG. 1, the advisor device 127 may be coupled by a fifth (5th) coupling 126 to the server 118.

AAE 128

With reference to FIG. 9, the AAE 128 manages the presentation of instances of visible data 132 and/or content 144 on the advisor device 127. The AAE also manages the capturing of annotations to the visible data 132 and/or the content 144 by the advisor. The AAE also manages the providing to the server 118 of the, as annotated, visible data 132, the, as annotated content 144, or the like. The server 118 may further provide such data to the client device 104 and/or the user device 102 for presentation thereby to a user and/or a client. For at least one implementation, operations of the AAE 128 are illustrated in FIG. 9 herein (as further described below). Such operations are non-limiting and for at least one implementation of the present disclosure. Other operations, sequences thereof, combinations, and/or permutations thereof may be used in accordance with other implementations of the present disclosure. For at least one implementation, the AAE 128 may be instantiated by an advisor device 127, where the advisor device 127 includes a processor configured to provide the AAE 128.

VDCE 103 Operations

As shown in FIG. 6 and Operation 600 and in accordance with at least one implementation of the present disclosure, a VDCE 103 may be instantiated by a user device 102 when a capture of visible data 132 is requested by a user, an automated process, an artificial intelligence logic, or otherwise. A non-limiting example of a visible data capture being requested may occur when a user is configuring a visible data medium 130 such as an electronic device (an example thereof being a network router), and an application program for so configuring the router instructs the user to capture an image of visible data 132 located on the router. Instantiation of the VDCE 103 may initiate visible data capture operations.

As shown in Operation 601, visible data capture operations may alternatively and/or additionally be initiated based upon an image capture component, such as a camera 134, being activated by a user device 102. Such activation may occur based upon a user input, another stimuli or event occurring, such as a motion being detected, a device status changing, a timer expiring, inputs received from an artificial intelligence logic, or otherwise. When the camera 134 is activated, an image may be captured. The image capture may occur manually, semi-automatically, automatically, or otherwise.

As shown in Operation 602, the visible data capture operations may include activating the camera 134 and capturing, as first visible data (“1VD”), an image of one or more objects within a field of view 136 of the camera 134.

As shown in Operation 604, the visible data capture operations may include performing image recognition operations to determine whether an image in the 1VD is recognizable. The image recognition operations may utilize any known or later arising image recognition technologies. For one implementation, an image recognition operation may be configured to detect textual, numerical and/or graphical information (such as QR codes) in an image. When visible data is recognized, the process may proceed to Operation 605. When visible data is not recognized using an automated image recognition operation, the process may proceed to Operation 606.

As shown in Operation 605, the visible data capture operations may include generating, from one or more portions of the recognizable 1VD, second visible data 132(2) (“2VD”). When an entirety of the 1VD is recognizable, the generating process may simply include a file status designation change. When multiple portions, but less than an entirety of the 1VD is recognizable, a user's input as to which portions of the 1VD to use to generate the 2VD. The process may proceed to Operation 614.

As shown in Operation 606, the visible data capture operations may include waiting for user input, if any, that identifies the image as containing visible data. For an implementation, the VDCE 103 may await determining a result of Operation 606 for any given time period, such as a default time period, a user specified time period, or otherwise. For another implementation, the VDCE 103 may interrupt any waiting period based upon another user action, such as another image being captured by the camera 132, the camera 132 being deactivated, or otherwise. It is to be appreciated that other camera 132 processing routines, such as a display of an image on the client device display 116 or other display may occur, as may other image processing operations. Such other image processing operations may provide a user with a given amount of information and visible data processing operations may not be needed, with respect to a given image. When no user input or other user action is indicated, with respect to visible data enhancements operations, the process may proceed to Operation 608.

As shown in Operations 608 and 610, the visible data capture operations are effectively terminated and other, if any, image processing actions may be performed with respect to the captured image. Non-limiting examples of such other image processing operations may include saving the image in the user device data store 104, uploading the image to an Internet based server for other uses, such as an INSTAGRAM server, taking no further actions with respect to the captured image, or otherwise.

As shown in Operation 612, the visible data capture operations may include determining whether the user input includes an indication of a visible data form (e.g., the image includes text, code, serial numbers, or the like). When the user input indicates that the image includes a visible data form, the process may proceed to Operation 605 (as described above). When the user input does not indicate that a visible data form is present in the captured image, the process may proceed with Operation 608 (as discussed above).

As shown in Operation 614, the visible data capture operations may include determining whether the 2VD includes actionable data. It is to be appreciated that not all of the visible data in a 2VD may be actionable. For example, a label identifying forms of streaming content supported by a given visible data medium 130 may not provide actionable data. Herein, “actionable data” is data, provided in a 2VD, that is useful in taking an additional action with respect to one or more portions of the 2VD and/or a given visible data medium 130. Non-limiting examples of such actions include powering the visible data medium 130 on, resetting it, connecting it to other devices, or otherwise. For at least one implementation, a VDCE 103 may be configured and/or updated to recognize specific forms of data presented in a 2VD as actionable data. Non-limiting examples of actionable data include QR codes, bar codes, product serial numbers, product model numbers, MAC addresses, or the like. When the 2VD does not include actionable data, the process may proceed to Operation 606 and a wait for further user input, if any, and when further user input is provided to Operation 614.

As shown in Operation 616, the visible data capture operations may include manipulating the actionable data in the 2VD into third visible data 132(3) (“3VD”).

As shown in Operation 618, the visible data capture operations may include coupling the user device 102 with a client device 104 (if not previously coupled).

As shown in Operation 620, the visible data capture operations may include sending the 3VD (and one or more additional enhancements provided by the server 118, if any, as per Operations 622-628) to the client device 104. The client device 104 may then display the 3VD (and/or additional enhancement) or perform other operations. As discussed above, the 3VD may include results from one or more image processing operations performed on the 1VD, recognized therein, and generated in the 2VD. Such image processing operations may include any known or later arising image processing operations. For at least one implementation, an image processing operation performed on the 1VD may include an enlargement thereof such that the 2VD, as generated, may present the captured image and/or actionable data in a format, as the 3VD, on the user device display 138 that is easier for a given user to read or interpret (for example, the 2VD has a larger font than the 1VD). Similar operations may be performed with respect to the 2VD and in the generation and outputting of the 3VD. In performing image processing operations, the VDCE 103 may take into consideration whether the 1VD and/or 2VD satisfies a given “small” threshold. As discussed above, the “small” threshold may be specified by default settings, a preference, based on use of machine learning and artificial intelligence processes, and/or otherwise.

As shown in Operation 622, the visible data capture operations may include determining whether to provide additional enhancement(s) to the 3VD. If “no,” the process may proceed to Operation 608. If “yes”, the process may proceed to Operation 624.

As shown in Operation 624, the visible data capture operations may include establishing a couplings of the user device 102 with the server 118 and the client device 104 with the server 118. For an implementation, both the user device 102 and the client device 104 are coupled with the server 118. For another implementation, only the user device 102 may be coupled with the server 118. For another implementation, only the client device 104 may be coupled with the server 118.

As shown in Operation 626, the visible data capture operations may include requesting additional enhancement of the 2VD by the server 118. As discussed above, the server 118 may be configured to instantiate a visible data display engine VDDE 114 for providing such additional visible data enhancements. Any type, quantity and/or form of additional visible data enhancements may be requested of the server 118 and the VDDE 114. Non-limiting examples of additional visible data enhancements include adjustments to contrast, focus, hue, darkness/lightness, saturation or the like, character and/or textual recognition, requesting of content 144, such as by proceeding to a web address identified by a QR code and retrieving content therefrom, or otherwise.

For at least one implementation, a user device 102 may proceed directly from Operation 605 and/or Operation 614 to Operation 624 and without performing one or more intermediary operations, such as Operations 616, 618, 620 and/or 622. It is to be appreciated that such a procession may occur when the user device 102 lacks one or more capabilities (as may be expressed in terms of hardware and/or software) to perform such operations with respect to one or more instances of 1VD, 2VD and/or 3VD.

As shown in Operation 628, the visible data capture operations may include determining whether the requested additional visible data enhancements have been received from the server 118. Operation 628 may occur for any given period of time and may consider one or more of the factors discussed above with regard to Operation 606. If additional or requested visible data enhancement(s) are not timely received, the process may proceed to Operation 608. Otherwise, the process may proceed to Operation 630.

As shown in Operation 630, the visible data capture operation may include determining whether assistance of an advisor, as technologically represented by an advisor device 127, is to be provided. If assistance is to be provided, the process may proceed to Operation 608. If advisor assistance is to be provided, the process may proceed to Operation 632.

As shown in Operation 632, the visible data capture operations may include coupling the server 118 to an advisor device 127 and requesting assistance. The process may also and/or alternatively proceed with the user device 102 coupling with the advisor device 127 and/or the client device 104 coupling with the advisor device 127. The assistance provided by the advisor device 127 may vary by use of a given implementation of the present disclosure. The assistance may include identifying content related to the second visible data 132(2) and/or third visible data 132(3). The assistance may include requesting the advisor, which may be a person, machine process, automated application, artificial intelligence, or otherwise, to annotate content, such as by identifying where a particular button is on a given visible data medium, how to connect a cable with a given device, or otherwise. The advisor may provide any annotation and in any form or format, including audible, visible, other, and permutations and combinations thereof.

As shown in Operation 634, the visible data capture operations may include determining whether assistance of the advisor has been provided. Such determination may include determining if any assistance provided is sufficient or if additional assistance is needed. If additional assistance is needed, Operation 632 may be repeated as many times as desired. If assistance has not been provided, the process may proceed to Operation 608. Operation 634 may occur for any given period of time and may consider one or more of the factors discussed above with regard to Operation 606. If advisor assistance has been provided and additional assistance is not needed the process may proceed to Operation 636.

As shown in Operation 636, the visible data capture operations may include receiving the annotation(s) and presenting the annotations on one more of the user device 102 and/or the client device 104. Operations 630-632-634-636 may be repeated as many times as is desired until advisor assistance is provided, or the process proceeds to Operation 608. The process may proceed to Operation 610 and end.

It is to be appreciated that the operations described above and depicted in FIG. 6 are illustrative and are not intended herein to occur, for implementations of the present disclosure, in the order shown, in sequence, or otherwise. One or more operations may be performed in parallel, and operations may be not performed, as provided for any given use of an implementation of the present disclosure.

VDPE 124 Operations

As shown in FIG. 7 and Operation 700 and in accordance with at least one implementation of the present disclosure, a VDPE 124 may be instantiated by a server 118 and therewith initiate visible data enhancement operations. For at least one implementation, the VDPE 124 may be instantiated, and visible data enhancement operations commence when a request for additional enhancement of second visible data 132(2) and/or third visible data 132(3) is requested by one or both of a user device 102 and/or a client device 104.

As shown in Operation 702, the visible data enhancement operations may include receiving one or both of the first visible data 132(1) and the second visible data 132(2) from the user device 102 and/or the third visible data 132(3) from the user device 102 or the client device 104.

As shown in Operation 704, the visible data enhancement operations may include performing one or more enhancements to the received visible data and generating a next instance of the visible data. For example, a received second visible data 132(2) may be enhanced by changing a font for characters in the second visible data 132(2) to a dyslexia friendly font, as provided in a third visible data 132(3).

As shown in Operation 706, the visible data enhancement operations may include identifying actionable data in the received visible data. For an implementation, the VDPE 124 may be configured to perform one or more of the operations described in Operation 612 to identify actional information in the received visible data.

As shown in Operation 708, the visible data enhancement operations may include the VDPE 124 utilizing information available on the Internet to identify content pertinent to actionable data. For example, a VDPE 114 may recognize that a given visible data medium 130 includes visible data that identifies a given manufacturer and a given product model. Using web site(s) provided by the given manufacturer enhance the visible data to include additional content pertinent to the given visible data medium 130.

As shown in Operation 710, the visible data enhancement operations may include communicating the next instance of the visible data 132(n) to the user device 102 and/or the client device 104.

As shown in Operation 712, the visible data enhancement operations may include communicating content to the user device 102 and/or the client device 104. The process may then end, as shown in Operation 714.

It is to be appreciated that the operations described above and depicted in FIG. 7 are illustrative and are not intended herein to occur, for implementations of the present disclosure, in the order shown, in sequence, or otherwise. One or more operations may be performed in parallel, and operations may be not performed, as provided for any given use of an implementation of the present disclosure.

VDDE 114 Operations

As shown in FIG. 8 and Operation 800 and in accordance with at least one implementation of the present disclosure, a VDDE 114 may be instantiated when a client device 104 receives a request from a client, a user device 102, or a server 118 to present visible data. For at least one implementation, the request may be sent by the user device 102 pursuant to Operation 618 of FIG. 6. The process may proceed to Operation 808.

As shown in Operation 802 and in accordance with at least one implementation of the present disclosure, a VDDE 114 may be instantiated when a client device 104 receives an instruction which instructs the client device 102 to initiate visible data display operations. The client and the user may be the same person or another person. The process may proceed to Operation 806.

As shown in Operation 804 and in accordance with at least one implementation of the present disclosure, a VDDE 114 may be instantiated when a client device 104 receives a request from a server 118 to present visible data. For at least one implementation, the server may send the request pursuant to Operation 710 of FIG. 7. The process may proceed to Operation 810.

As shown in Operation 806, the visible data display operations may include an inquiry as to whether visible data is to be received from the user device 102 or the server 118. If from the user device 102, the process may proceed to Operation 808. If from the server 118, the process may proceed to Operation 810.

As shown in Operation 808, the visible data display operations may include coupling with the user device 803. The process may proceed to Operation 812.

As shown in Operation 810, the visible data display operations may include coupling with the server 118. The process may proceed to Operation 814.

As shown in Operation 812, the visible data display operations may include receiving third visible data 132(3) from the user device 102. The process may proceed to Operation 816.

As shown in Operation 814, the visible data display operations may include receiving third visible data 132(3) from the server 118. The process may proceed to Operation 816.

As shown in Operation 816, the visible data display operations may include determining whether the received visible data, as received from the user device 102, the server 118, or both, is adequate for its intended use. The as received third visible data 132(3) may be in a form ready for immediate presentation by the client display device 116 and/or in a form requiring additional visible data enhancements, such as enlargement of the as received third visible data 132(3) into a different sized fourth visible data (not shown). If “no”, the process may proceed to Operation 818. If “yes”, the process may proceed to Operation 820.

As shown in Operation 818, the visible data display operations may include requesting additional and/or alternative visible data from one or more of the user device 102, the server 118 and/or both. As shown, the request may include Operations 82 and/or 814. For at least one implementation, the VDDE 114 may be configured to determine visible data enhancement capabilities of the VDCE 103 and the VDPE 124. Such capabilities may be identified in the client device data store 404, the user device data store 204 and/or the server data store 304.

As shown in Operation 820, the visible data display operations may include receiving and presenting visible data on the client device display 116.

As shown in Operation 822, the visible data display operations may include determining whether content 144 is to be requested. It is to be appreciated that a request for content 144 may be generated automatically, semi-automatically, and/or manually. The request may be based on a user's actions and/or inactions in response to the receiving and presenting of the visible data. For example, upon receiving visible data providing an enhancement of a serial number provided on a visible data medium 130, the process may include requesting content when the serial number is not timely provided in a data field for a web form an application form, or otherwise. A request for content may be generated for any reason or no reason, such as for any given enhancement of visible data.

As shown in Operation 824, the visible data display operations may include receiving and presenting the content on the client device display 116. For at least one implementation, the content may be presented with or separate from received visible data on the client device display 116.

As shown in Operation 826, the visible data display operations may include requesting annotation of the third visible data 132(3) and/or any content provided to the client device 104. The annotations may be requested, for example, when a client, upon receiving the third visible data 132(3), which may be enhanced by the user device 102 and/or the server 118, remains uncertain as to what additional actions the client is to perform (and/or not perform, as the case may be). If annotation is requested, the process proceeds to Operation 828. If annotation is not request, the process proceeds to Operation 832.

As shown in Operation 828, the visible data display operations may include receiving annotations from an advisor device 127 and presenting the annotations to a client. The annotations may have any form, feature and/or function and may be presented to a client in any given manner, such as audibly, visibly, and/or otherwise.

As shown in Operation 830, the visible data display operations may include multiple annotations be received and presented. For example, an annotation may include a sequence of operations that an advisor communicates to a client. As the client performs a given operation, the advisor may proceed to send another annotation. Operations 828-830 may repeat as necessary until one or more given annotations are communicated by an advisor to the client. For example, annotations directing a client to locate an incoming Ethernet port on a router might include: (1′ annotation) identify back of router; (2nd annotation) identify incoming Ethernet port on back of router (for example, highlighting the port as presented in content sent to the client device); (3rd annotation) orienting Ethernet cable jack properly; (4th annotation) inserting Ethernet cable into incoming Ethernet port until a “clicking” sounds is heard; and (5th annotation) verifying the Ethernet cable is securely seated in the incoming Ethernet port by gently tugging on the Ethernet cable with one hand while holding the router in another hand.

As shown in Operation 832, the visible data display operations may include determining whether additional content is to be requested. If yes, the process proceeds to operation 822. If no, the process proceeds to Operation 834. It is to be appreciated that one or more implementation of systems, devices and processes for visible data enhancement may involve multiple operations to be performed by a client. The multiple operations may benefit from multiple instances of content, such as those provided by a user manual, a training video, or otherwise.

As shown in Operation 834, the visible data display operations may include repeating Operations 806-834 until one or more instances of visible data are enhanced, with such enhancements potentially also including presenting to a client one or more instance of content and/or annotations. Once the visible data enhancements, content and/or annotations are presented to a client, the process may end, as per Operation 836.

It is to be appreciated that the operations described above and depicted in FIG. 8 are illustrative and are not intended herein to occur, for implementations of the present disclosure, in the order shown, in sequence, or otherwise. One or more operations may be performed in parallel, and operations may be not performed, as provided for any given use of an implementation of the present disclosure.

AAE 128 Operations

As shown in FIG. 9 and Operation 900 and in accordance with at least one implementation of the present disclosure, annotation operations managed by the AAE 128 may be instantiated upon an advisor device 127 receiving an instance of visible data 132 and/or content 144 with respect to which an advisor is requested to provide additional content 144 and/or annotations 146. As discussed herein above, an advisor may be a person, an automated process, an artificial intelligence, a combination of the foregoing, or the like. The annotation request, content 144 and/or instance of visible data 132 may be received, by the advisor device 127, from one or more of a user device 102, a client device 104, a server 118 and/or another advisor device 127.

As shown in Operation 902, the annotation process may include identifying a type of annotation to be performed. Non-limiting examples of annotation types include annotate visible data 132, annotate content 144, retrieve additional content, annotate additional content, or otherwise.

As shown in Operation 904, the annotation process may include determining whether the annotation request is with respect to visible data 132, such as the second visible data 132(2) and/or the third visible data 132(3). It is to be appreciated that visible data that has been annotated may be identified as a new or edited file separately in a file system or may replace a given instance of a file. When visible data 132 is to be annotated the process proceeds to Operation 906.

As shown in Operation 906, the annotation process may include capturing the annotations. Such capturing may occur directly or indirectly by the advisor device 127 and the AAE 128. The annotations may be provided by an advisor or other entity and captured in any form. Non-limiting examples of forms of annotations include: textual annotations (e.g., correction of typed character); graphical annotations (e.g., highlighting of existing text or graphics, adding new and/or replacement text or graphics); visual annotations (e.g., providing a link or copy of a video that is relevant to the visible data, one example being a link to a YOUTUBE video); audible annotations (e.g., providing verbal instructions regarding the visible data); augmented reality annotations; virtual reality annotations; other forms of annotations; and combinations of one or more of the foregoing. For at least one implementation, an advisor device 127 and AAE 128 may be configured for use with any known or later arising technologies, including advisor I/O interface technologies, which facilitate and support annotation of visible data, content, and other forms of data and/or information.

As shown in Operation 908, the annotation process may include processing a given annotation into a data format compatible for communication to other elements of the system 100, such as the server 117 and client device 104. Such processing resulting in communications data (“annotated data”). This processing may be determined in view of a given form of annotation utilized. For a non-limiting example, video annotations may be processed into a Motion Picture Experts Group (MPEG) format, such as MPEG 2/4 or other.

As shown in Operation 910, the annotation process may include outputting the annotated data for delivery to one or more system 100 components, such as the server 117, client device 104 and/or user device 102. As further shown, one or more of Operations 906-908-910 may be iteratively performed. For example, a live streaming of an annotation may include capturing an advisor's annotation, substantially simultaneously converting it into annotated data, and substantially simultaneously outputting the annotated data. Similarly, a recorded annotation may involve performing one or more of operations 906, 908 and 910 in segments (e.g., as a designated storage buffer, or the like in the advisor device 127 is filled), in bulk, or otherwise. The AAE 128 may be configured to support streaming, recorded, segmented, or other approaches to providing annotations by an advisor to a client.

As shown in Operation 912, the annotation process may include determining whether an additional annotation request has been received. For example, during a first annotation, a client may have requests for additional annotations. If so, one or more of the operations of FIG. 9 may be performed with respect to any additional annotation requests.

As shown in Operation 914, the annotation process may end when received annotation requests have been addressed, or otherwise terminated. It is to be appreciated that a given annotation request may be beyond the scope of an advisor's knowledge, capabilities, or otherwise. Accordingly, the AAE 128 may be configured to perform annotation consultations with others more knowledgeable or capable with respect to a given annotation request. For example, an annotation request by a user regarding a medication may be first sent to a relative, who may be knowledgeable of a given prescriptions instructions. A request for whether a dosing could be skipped or otherwise addressed may be beyond the knowledge of the relative and may require a consultation with a pharmacist, prescribing doctor or the like, drug company, or otherwise. The AAE 128 may be configured to facilitate annotation consultations by use of any known or later arising technologies, with non-limiting examples including text messaging, application messaging, voice messaging, audio/video/web conferencing, use of artificial intelligence processes and the like.

As shown in Operation 916, the annotation process may include determining whether the annotation request is with respect to annotating content. If so, Operations 906-910 may be performed. It is to be appreciated that Operations 904 and 916 may occur substantially simultaneously or separately. For example, an advisor may annotate both visible data 132 and content 144 substantially simultaneously.

As shown in Operation 918, the annotation process may include a request for the advisor to retrieve additional content. Such a request may occur in relation to the visible data 132 and/or already retrieved content 144 or with respect to another related or unrelated topic. For example, a user may request an advisor for annotations regarding their router and further request the advisor for annotations regarding something else, for example, how to clean a coffee maker or the like. When such a request for additional content is received, the process proceeds to Operation 920. When such a request for additional content is not received, the process may proceed, per Operation 919, with further processing any current annotation requests or determining if another annotation request is received, as per Operation 912.

As shown in Operation 920, the annotation process may include the advisor and/or an annotation consultant identifying and retrieving the requested additional content. Any known or later arising technologies for identifying and retrieving such additional content may be used with a non-limiting example including use of search engines, such as GOOGLE, BING, and others, or otherwise.

As shown in Operation 922, the annotation process may include receiving, from the advisor and/or an annotation consultant, annotations to one or more instance of the identified and retrieved additional content. It is to be appreciated that the additional content may be provided to the client without annotation, when so desired for a given implementation.

As shown in Operation 924, the annotation process may include capturing the additional content annotations. For an implementation, one or more of the processes of Operation 906 may be used.

As shown in Operation 926, the annotation process may include processing the additional content annotations into additional annotated data. For an implementation, one or more of the processes of Operation 908 may be used. The additional annotated data may be output to a system 100 component separately and/or in jointly with one or more instances of annotated data, as per Operation 910.

It is to be appreciated that the operations described above and depicted in FIG. 9 are illustrative and are not intended herein to occur, for implementations of the present disclosure, in the order shown, in sequence, or otherwise. One or more operations may be performed in parallel, and operations may be not performed, as provided for any given use of an implementation of the present disclosure.

Although various embodiments have been described above with a certain degree of particularity, or with reference to one or more individual embodiments, those skilled in the art could make numerous alterations to the disclosed embodiments without departing from the spirit or scope hereof. The use of the terms “approximately” or “substantially” means that a value of an element has a parameter that is expected to be close to a stated value or position. As is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes and are not intended to be limiting to any orientation or configuration of any elements or sequences of operations for the various embodiments of the present disclosure. Further, the terms “coupled”, “connected” or otherwise are not intended to limit such interactions and communication of signals between two or more devices, systems, components or otherwise to direct interactions; indirect couplings and links may also occur. Further, the terms “and” and “or” are not intended to be used in a limiting or expansive nature and cover any possible range of combinations of elements and operations of an implementation of the present disclosure. Other embodiments are therefore contemplated. It is intended that matter contained in the above description and shown in the accompanying drawings shall be interpreted as illustrative of embodiments and not limiting. Changes in detail or structure may be made without departing from the basic elements of the present disclosure as defined in the following claims.

What is claimed is:

1. A process, for enhancing visible data by a user device, comprising:
initiating a visible data capture on a user device;
capturing, as first visible data (1VD), an image of an object within a field of view of a camera coupled to the user device;
determining whether the 1VD includes recognizable data;
when recognizable data exists in the 1VD, generating second visible data (2VD) from the 1VD;
determining whether actionable data exists in the 2VD;
manipulating the actionable data in the 2VD into third visible data (3VD);
coupling the user device with a client device; and
sending the 3VD to the client device for presentation on a client device display.

2. The process of claim 1,
wherein the 3VD includes an enhancement to the actionable data in the 2VD.

3. The process of claim 2,
wherein the enhancement changes at least one character in the 2VD from a first font size to a second font size.

4. The process of claim 2,
wherein the enhancement adjusts a visible characteristic of the 2VD.

5. The process of claim 4,
wherein the visible characteristic of the 2VD adjusted is at least one of a contrast,
shading, hue, tint, brightness characteristic of the 2VD.

6. The process of claim 1,
wherein the 1VD identifies a serial number of the object.

7. The process of claim 1,
wherein the user device is a mobile phone and the user device include a user device display; and
wherein the client device display is larger than the user device display; and
wherein the 3VD presents a larger representation of the actionable data in the 2VD using the client device display than is otherwise possible using the user device display.

8. The process of claim 7,
wherein a given person is both a user of the user device and the client.

9. The process of claim 1, further comprising:
determining whether to provide an additional enhancement to the 2VD;
when the additional enhancement is to be provided,
coupling the user device with a server;
providing the 2VD to the server;
requesting the additional enhancement from the server to the 2VD; and
receiving the additional enhancement from the server; and
wherein the additional enhancement is provided to the client device by one of the user device and the server.

10. The process of claim 9,
wherein the server is configured to execute non-transient computer instructions which instruct the server to generate and provide the additional enhancement by performing processor executable operations comprising:
receiving the 2VD from the user device;
enhancing the 2VD into a next instance of the 2VD;
communicating the next instance of the 2VD to the user device;
determining whether actionable data is present in the 2VD;
when actionable data is present in the 2VD,
identifying content pertinent to any actionable data in the 2VD; and
communicating the content to the user device.

11. The process of claim 10, further comprising:
presenting the content on a user device display; and
communicating the content to the client device for presentation on a client device display.

12. The process of claim 9, further comprising:
determining whether advisor assistance is to be provided; and
when advisor assistance is to be provided,
coupling the user device with an advisor device;
requesting assistance from the advisor device;
determining whether the requested assistance is provided; and
when the requested assistance is provided,
receiving at least one annotation from the advisor device; and
directly or indirectly communicating the at least one annotation to the client device.

13. The process of claim 12,
wherein the indirectly communicating of the at least one annotation occurs via a fifth coupling of the advisor device with the server, a fourth coupling of the server with a gateway, and a third coupling of the gateway with the client device.

14. The process of claim 1, further comprising:
determining whether advisor assistance is to be provided; and
when advisor assistance is to be provided,
coupling the user device with an advisor device;
requesting the advisor assistance from the advisor device;
determining whether the requested advisor assistance is provided; and
when the requested advisor assistance is provided,
receiving an advisor annotation from the advisor device; and
directly or indirectly communicating the advisor annotation to the client device.

15. The process of claim 14,
wherein the indirectly communicating of the advisor annotation occurs via a fifth coupling of the advisor device with a server, a fourth coupling of the server with a gateway, a second coupling of the gateway with the user device, and a first coupling of the user device with the client device.

16. The process of claim 15,
wherein the gateway forms a local area network which couples the user device with the client device via the second coupling and the third coupling.

17. The process of claim 14, further comprising:
when the requested advisor assistance is provided:
receiving additional content from the advisor device;
wherein the additional content relates to at least one of the advisor annotation, the 2VD and the 3VD.

18. The process of claim 17,
wherein the advisor annotation includes an annotation of the additional content.

19. The process of claim 18,
wherein the advisor annotation is provided in at least one of a textual annotation, a graphical annotation, a visual annotation, an audible annotation, an augmented reality annotation, and a virtual reality annotation.

20. The process of claim 19,
wherein the object is an electronic device;
wherein the 1VD provides a serial number for the electronic device;
wherein the advisor annotation is with respect to a data port for the electronic device; and
wherein the additional content is a video providing instructions for coupling the electronic device to another electronic device.
